(19) United States
(12) Patent Application Publication
(10) Pub. No.: US 2019/0297265 A1
(43) Pub. Date: Sep. 26, 2019

(54) USER-FEEDBACK VIDEO STABILIZATION DEVICE AND METHOD

(71) Applicant: Sawah Innovations Inc., Lindsay (CA)

(72) Inventor: Ziad Elsawah, Lindsay (CA)

(73) Assignee: Sawah Innovations Inc., Lindsay (CA)

(21) Appl. No.: 15/928,038

(22) Filed: Mar. 21, 2018

(51) Int. Cl. H04N 5/232

(52) U.S. Cl. CPC H04N 5/23293; H04N 5/23222; H04N 5/23258; H04N 5/23254

(57) ABSTRACT

A device and method to provide the user of a video recording device, like a smartphone, on-screen feedback to control the stability of the output video. The demarcation of a shape on the screen indicates the bounds of the material to be included in the resultant output video. The shape moves, as required, on the screen in the direction intended to stabilize the video. Device embodiments may also comprise facilitations for maintaining the shape's location relative to the screen, in the event that the shape hits one of the screen's edges; in that way, the video recording can accommodate scene movements. Other embodiments provide capability for locking onto a physical location in space, regardless of camera position or orientation.

### FIELD OF INVENTION

The present invention is in the field of computer engineering, and specifically, non-stationary video recording devices. More particularly, the present invention relates to methods and devices for actively controlling the stability of video recording devices.

### BACKGROUND OF INVENTION AND DESCRIPTION OF PRIOR ART

A recurring problem with video recording is the stability of the device, and hence the perceived stability of the video being recording. The problem is compounded for handheld video recorders as the motion of the holder is often jittery. While some purpose-built devices contain mechanical and optical devices to aid in stabilizing the video, most classes of hand-held video-recorders like smartphones lack the benefit of these physical stabilizing devices. In addition, the incorporation of mechanical and optical devices for stability often adds cost and bulkiness to the overall design.

Current state of the art software relies on several different ways to stabilize video. The first is to compare the images from frame to frame. Each frame may be divided into macro blocks and then each block would be compared to its analogue on a successive frame. After the images are compared, the motion vector is established by the direction the stationary items in the frame have moved. The calculation may take into consideration factors other than linear translation like zoom, and camera orientation/rotation angle.

Another technique samples motion information from other sensors in the handheld device like gyroscopes or accelerometers. Jittery unintended motion may be classified as any motion under a certain threshold of magnitude. Successive image frames are then modified to correct for the jittery motion observed.

Sensor information on video recorder location on orientation is often rough discreet readings at certain time intervals. Smoothening that graph, say of camera orientation for example, helps ensure better image stabilization. Some algorithms also work to reduce the lag between motion and the time it is recorded by the sensor. Smoothening that graph will help ensure better stabilization as well.

Moving a frame to make it more stable can be made by zooming in to leave room for the pixels in the periphery to be used in translation. Another way to stabilize the image is to intentionally create an image sensor that has an additional margin of error. That margin is a periphery of pixels specifically available to be used for the purposes of stabilization.

All methods described above leave little for the user to see, let alone control. These stabilization techniques address unintended motion of a jittery nature. They do not smoothen intended motions of the user and/or the video recording device. They do not provide a way for the user to actively control the stability of the video and scene changes within.

### SUMMARY OF THE INVENTION

One objective of the device and method described herein is to provide the user of a video recording device, like a smartphone, on-screen feedback to control the stability of the output video. That can be achieved by the demarcation of a moving shape on a screen. Henceforth, the words “shape” and “box” will be used interchangeably in reference to the bounding shape on the screen, even though the resultant shape need not necessarily be a rectangle. The box on the screen is stabilized by moving on the screen in a direction opposite to that of the motion of the recording device. That comparison can be done in a multitude of established ways. Each successive frame may be compared to the one before in order to ascertain the motion of the device compared to the objects on the screen. Sensor information for the motion of the device, like that of a gyroscope or an accelerometer, may be used as well. The motion of the box on the screen would oppose the motion of the device in order to convey stability. In order to record with this form of stability, it is understood that the video output will never make use of the entire pixel capability of the image sensor, as there will always be a buffer sacrificed for the functionality gained.

Some embodiments might feature the recording box, where the location that the box refers to in physical space changes, as the box hits the edges of the screen. Others might control the position of the box by using a spring-like motion to pull the box back to the centre of the screen or any other specified location on the screen. That motion might have specific acceleration or velocity assigned to it at any specific point in time. Such acceleration or velocity may lie constant or variable. Such acceleration or velocity may depend on the distance between the box's current location, and the desired final location.

Moreover, some embodiments might do away with the box altogether while the background algorithms discussed in this invention are still in operation.

Motions being studied for this device and method include translation motion in the 3 physical axes as well as rotation around each of the 3 axes. Some embodiments may choose to limit the actionable device motion information to any single datum or combination of data.

Some embodiments might feature a locking mode that only records a prescribed location in physical space. For example, to compensate for translation motion of the recorder, the box would not change form but would only move in the opposite direction to compensate and continue to record the same articles in the same physical space. However, if the image sensor orientation were to change angle around a single axis, the box would no longer be a rectangle, and the box would morph into a trapezoid to compensate and continue to record the same articles in the same physical space. This locking mode might make use of image frame comparisons and/or depth sensor information as well.

Embodiments may take the form of software applications. These software applications may be apps on handheld smartphones. These apps may further take the form of independent apps that achieve the functionality described. They may be apps that integrate this functionality with other existing functionalities of a camera app. They may also be integrated within the functionality of a stock camera application that is standard with a smartphone operating system. Current examples include the camera apps that are a standard part of the Apple's iOS smartphone operating system, as well as those that are a standard part of Google's Android smartphone operating system. Future developments in operating systems and application stores have been contemplated within the scope of this invention.

The applications of the devices and methods discussed above are not limited only to handheld video recorders. but may also include any number of further applications. Moreover, such devices and methods may be applied to other problems as seen frt. Modification of the above-described assemblies and methods for carrying out the invention, combinations between different variations as practicable, and variations of aspects of the invention that are obvious to those of skill in the art are intended to be within the scope of the claims.

### BRIEF DESCRIPTION OF THE DRAWINGS

FIG. 1 illustrates a video recording device with a screen, in this case a smartphone.

FIG. 2 shows the smartphone with a shape, in this case a rectangle, on the screen indicating the bounds of the output video, as well as the objects of interest being recorded.

FIG. 3 shows the smartphone about to move in one direction as the video output bounding box moves in the opposite direction.

FIG. 4 shows the location of the smartphone, box, and objects of interest after the move.

FIG. 5 shows the video output box hitting the left edge of the screen, where it remains as the smartphone continues to move towards the right.

FIG. 6 shows the automatic re-centering of the box to the centre of the screen, another method for the box to move on the screen.

FIG. 7 shows a smartphone about to undergo a rotation, along with the bounding box for video output, as well as the object of interest in the video.

FIG. 8 shows a smartphone after rotation along with the morphed shape of the video output bounding trapezoid, along with the distorted object of interest compared to the original frame.

### DETAILED DESCRIPTION OF THE PREFERRED EMBODIMENTS

It should be reiterated that the embodiments described in the figures and in the following description are those of a few embodiments only. Such other embodiments that would be apparent to those skilled in the relevant art(s) to which the invention pertains are also contemplated herein.

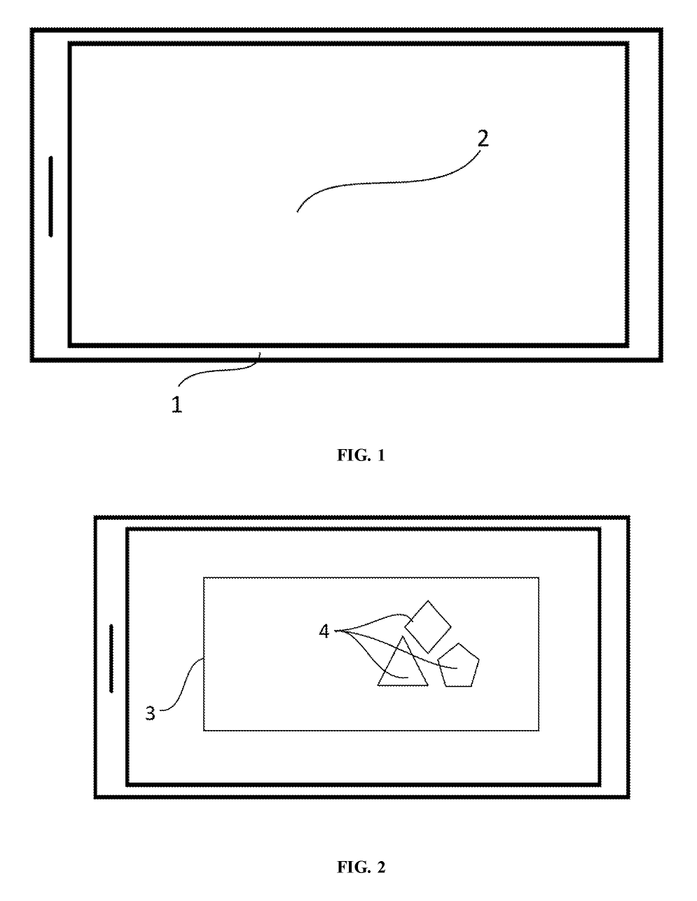

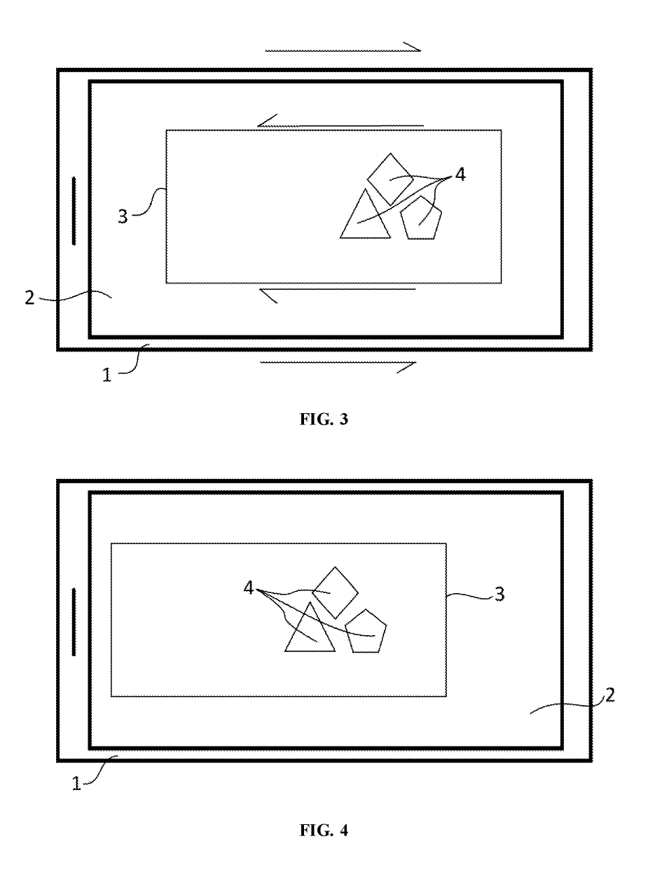

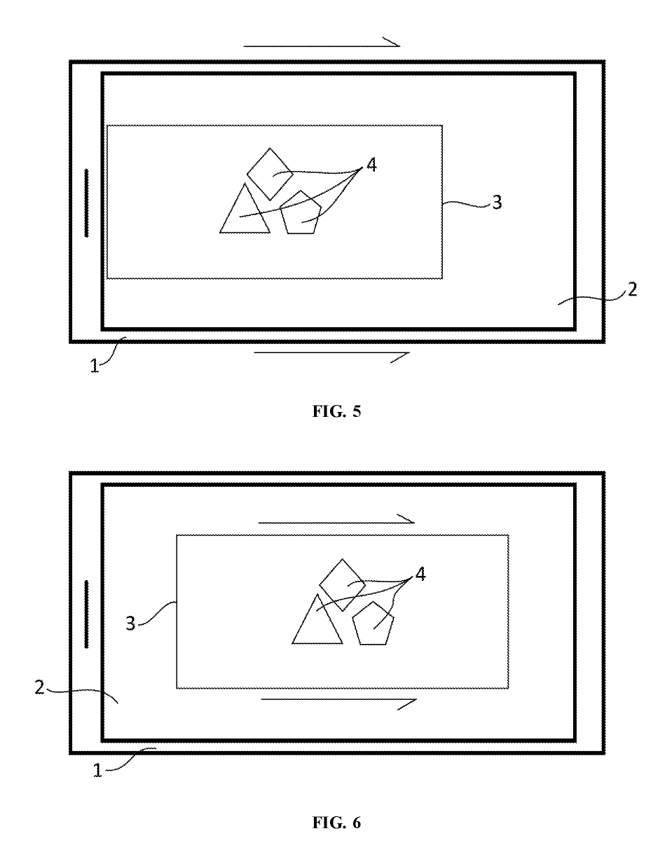

Turning to the drawings, FIG. 1 illustrates a video recording device 1 with a screen 2. For the sake of an example, the device 1 shown here is a smartphone. FIG. 2 illustrates the smartphone 1 where a camera view is seen on the screen 2, including the output video bounding area 3 and the object(s) of interest 4. It should be mentioned that the shape of the output video bounding area 3 can be that of any shape, but is shown here and in the successive figures as a quadrilateral for the sake of simplicity. FIG. 3 illustrates the smartphone 1 about to move in one direction, where the bounding box 3 will attempt to remain focused on the same object(s) of interest 4 in the same area of physical space, so the box 3 will move in the opposite direction. FIG. 4 shows the location of the smartphone 1, box 3, and objects of interest 4 after the move on the screen 2. If the motion shown in FIG. 3 continues, the box 3 will hit the edge of the screen 2 of the smartphone 1. FIG. 5 shows the smartphone 1 continuing in its described motion as the video output bounding box 3 remains in the same location on the screen 2, but of course the object(s) of interest 4 now occupy a new location relative to the video output box 3.

Another embodiment is featured in FIG. 6. After the motion described in FIG. 3, the box 3 is no longer in the centre of the screen 2. FIG. 6 shows a motionless smartphone 1 after the motion described in FIG. 3. However, an automatic re-centering process applies an acceleration to the box 3, dependent on the distance between the centre of the box 3 and the centre of the screen 2, to return the box 3 to the centre of the screen 2.

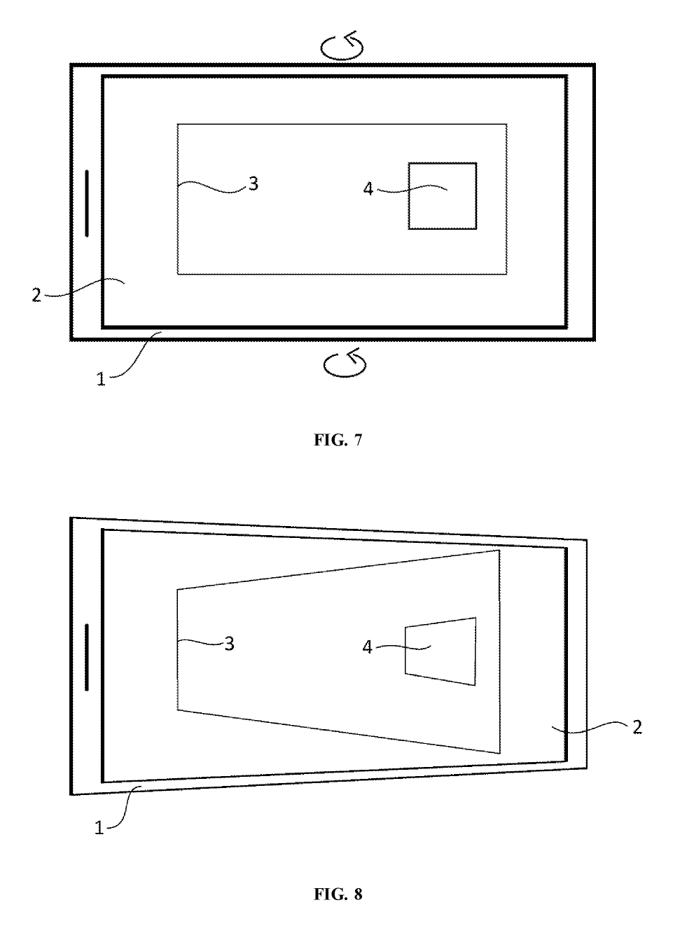

FIG. 7 describes another embodiment that examines how the software might deal with rotation. FIG. 7 illustrates a smartphone 1 about to undergo a rotation, along with the bounding box 3 for video output, as well as the object of interest 4 in the video. FIG. 8 shows the smartphone 1 after rotation, with object of interest 4 occupying a distorted figure on the screen 2 compared to the original frame. The bounding box 3 for the output video morphs into a trapezoid to compensate; resultant video will continue to be shown as a rectangle with the distortion corrected for. It is worth mentioning that the distortions shown in FIG. 8 are an exaggeration for clarification purposes; real effects may be much subtler.

I claim:

1. A video-recording device, wherein the user is provided on-screen feedback to control the stability of the output video comprising:
a shape to clearly indicate the contents of the resultant output video within it;
the motion of the shape in the direction intended to stabilize the video when such motion is required;
option where the translation motion of the device in the 3 physical axes as well as rotational motion around each of the 3 axes may not be fully taken into consideration, with a limit placed on the actionable device motion information to at least one datum;
algorithm wherein the motion of the shape on the screen in the direction intended to stabilize the video is in a direction approximately opposite of the motion of the video-recording device.

2. The device of claim 1, wherein the motion of the device is determined using at least one inertial sensor onboard the device, like an accelerometer.

3. The device of claim 1, wherein the motion of the device is determined using depth-field imaging sensors onboard the device.

4. The device of claim 1, wherein the motion of the device is determined using an analysis of the video with a frame to frame comparison.

5. The device of claim 1, where the option is provided to remove the space surrounding the shape off the bounds of the screen, with the algorithms of the device working in the background, but the screen only shows the contents of the output video.

6. The device of claim 1, wherein the location that the recording shape refers to in physical space changes as the box hits an edge of the screen, with the shape's relative location to the screen remaining constant.

7. The device of claim 1, wherein the location of the recording shape relative to the screen changes using a spring-like motion to pull the shape back to any specified location on the screen including the centre of the screen, with velocity assigned to the motion at any specific point in time;

8. The device of claim 7, where such velocity depends on an acceleration, in turn depending on the distance between the box's current location, and the desired final location.

9. A video-recording device, wherein the user is provided on-screen feedback to control the stability of the output video comprising:
a shape to clearly indicate the contents of the resultant output video within it;
the motion of the shape in the direction intended to stabilize the video when such motion is required;
option where the translation motion of the device in the 3 physical axes as well as rotational motion around each of the 3 axes may not be fully taken into consideration, with a limit placed on the actionable device motion information to at least one datum;
algorithm where the motion of the shape in the direction intended to stabilize the video is in a direction that maintains a recording of a particular physical location in space.

10. The device of claim 9, wherein the motion of the device is determined using at least one inertial sensor onboard the device, like an accelerometer.

11. The device of claim 9, wherein the motion of the device is determined using depth-field imaging sensors onboard the device.

12. The device of claim 9, wherein the motion of the device is determined using an analysis of the video with a frame to frame comparison.

13. The device of claim 9, where the option is provided to remove the space surrounding the shape off the bounds of the screen, with the algorithms of the device working in the background, but the screen only shows the contents of the output video.

14. The device of claim 9, wherein the location that the recording shape refers to in physical space changes as the box hits an edge of the screen, with the shape's relative location to the screen remaining constant.

15. The device of claim 9, wherein the location of the recording shape relative to the screen changes using a spring-like motion to pull the shape back to any specified location on the screen including the centre of the screen, with velocity assigned to the motion at any specific point in time;

16. The device of claim 15, where such velocity depends on an acceleration, in turn depending on the distance between the box's current location, and the desired final location.

17. A video-recording method, wherein the user is provided on-screen feedback to control the stability of the output video comprising:
a shape to clearly indicate the contents of the resultant output video within it;
the motion of the shape in the direction intended to stabilize the video when such motion is required;
option where the translation motion of the device in the 3 physical axes as well as rotational motion around each of the 3 axes may not be fully taken into consideration, with a limit placed on the actionable device motion information to at least one datum;
algorithm wherein the motion of the shape on the screen in the direction intended to stabilize the video is in a direction opposite of the motion of the video-recording device.

18. The method of claim 17, wherein the motion of the device is determined using at least one inertial sensor onboard the device, like an accelerometer.

19. The method of claim 17, wherein the motion of the device is determined using depth-field imaging sensors onboard the device.

20. The method of claim 17, wherein the motion of the device is determined using an analysis of the video with a frame to frame comparison.

21. The method of claim 17, where the option is provided to remove the space surrounding the shape off the bounds of the screen, with the algorithms of the device working in the background, but the screen only shows the contents of the output video.

22. The method of claim 17, wherein the location that the recording shape refers to in physical space changes as the box hits an edge of the screen, with the shape's relative location to the screen remaining constant.

23. The method of claim 17, wherein the location of the recording shape relative to the screen changes using a spring-like motion to pull the shape back to any specified location on the screen including the centre of the screen, with velocity assigned to the motion at any specific point in time;

24. The method of claim 23, where such velocity depends on an acceleration, in turn depending on the distance between the box's current location, and the desired final location.

25. A video-recording method, wherein the user is provided on-screen feedback to control the stability of the output video comprising:
a shape to clearly indicate the contents of the resultant output video within it;
the motion of the shape in the direction intended to stabilize the video when such motion is required;
option where the translation motion of the device in the 3 physical axes as well as rotational motion around each of the 3 axes may not be fully taken into consideration, with a limit placed on the actionable device motion information to at least one datum;
algorithm where the motion of the shape in the direction intended to stabilize the video is in a direction that maintains a recording of a particular physical location in space.

26. The method of claim 25, wherein the motion of the device is determined using at least one inertial sensor onboard the device, like an accelerometer.

27. The method of claim 25, wherein the motion of the device is determined using depth-field imaging sensors onboard the device.

28. The method of claim 25, wherein the motion of the device is determined using an analysis of the video with a frame to frame comparison.

29. The method of claim 25, where the option is provided to remove the space surrounding the shape off the bounds of the screen, with the algorithms of the device working in the background, but the screen only shows the contents of the output video.

30. The method of claim 25, wherein the location that the recording shape refers to in physical space changes as the box hits an edge of the screen, with the shape's relative location to the screen remaining constant.

31. The method of claim 25, wherein the location of the recording shape relative to the screen changes using a spring-like motion to pull the shape back to any specified location on the screen including the centre of the screen, with velocity assigned to the motion at any specific point in time;

32. The method of claim 31, where such velocity depends on an acceleration, in turn depending on the distance between the box's current location, and the desired final location.
